(19) United States
(12) Patent Application Publication
(10) Pub. No.: US 2013/0168042 A1
(43) Pub. Date: Jul. 4, 2013

(54) HEAT EXCHANGER HAVING CORRUGATED SHEETS

(71) Applicant: Praveen Kumar Garlapati, Hyderabad (IN)

(72) Inventor: Praveen Kumar Garlapati, Hyderabad (IN)

(73) Assignee: GENERAL ELECTRIC COMPANY, Schenectady, NY (US)

(21) Appl. No.: 13/343,551

(22) Filed: Jan. 4, 2012

(51) Int. Cl. F01P 9/00; B23P 15/26

(52) U.S. Cl. 165/51; 29/890.039; 165/170

(57) ABSTRACT

A heat exchanger having at least one corrugated sheet and a method of creating the heat exchanger are provided. The method includes providing at least one corrugated sheet. The at least one corrugated sheet has at least one joining portion and at least one groove portion. The method includes providing a joining surface for the at least one corrugated sheet. The method also includes joining the at least one corrugated sheet at the least one joining portion with the joining surface. The joining surface cooperates with the at least one groove portion of the at least one corrugated sheet to create at least one passageway. The at least one passageway is configured for the passage of fluid.

### BACKGROUND OF THE INVENTION

The subject matter disclosed herein relates to a heat exchanger and a method of creating a heat exchanger, and more specifically to a heat exchanger having at least two corrugated sheets that forms at least one or more passageways for the passage of a fluid medium, and are provided in multiples of two.

A heat exchanger for an electrical motor may be provided for heat dissipation. In one example of a heat exchanger, a series of crossover pipes are situated above the motor. The crossover pipes carry air that has been cooled by a blower or fan. A rotor of the motor includes fins formed by passages in the rotor core or stack, where rotation of the rotor directs the hot air created by operation of the motor towards the crossover pipes. The hot air is cooled by the crossover pipes, and is redirected back towards the rotor. The crossover pipes typically include a generally circular cross-section.

The crossover pipes have several drawbacks. For example, the crossover pipes commonly create a relatively large amount of air resistance. Consequently, a blower that is used to supply air must be more powerful to accommodate the air resistance created by the crossover pipes. Also, conventional crossover pipes tend to exhibit a relatively low stiffness. Therefore, a support member is generally required to accommodate the crossover pipes. The support member adds cost as well as mass to the motor. Also as a convection surface offered for heat transfer by the crossover pipes is relatively low, an increased number of crossover pipes are usually placed to meet the heat transfer requirement. Moreover, to reduce the occurrence of cooled air and hot air mixing together, a punched sheet is normally leak proof welded or otherwise attached to an entrance and an exit of the crossover pipes. The punched sheets or flats, similar to the support member, also add cost and complexity to the motor. Finally, manufacturing processes that are currently available to create the crossover pipes are usually time-consuming and relatively costly. Also, field reparability of crossover pipes for any leakage would be highly cumbersome and time taking.

### BRIEF DESCRIPTION OF THE INVENTION

According to one aspect of the invention, a method of creating a heat exchanger is provided. The method includes providing at least one corrugated sheet. The at least one corrugated sheet has at least one joining portion and at least one groove portion. The method includes providing a joining surface for the at least one corrugated sheet. The method also includes joining the at least one corrugated sheet at the least one joining portion with the joining surface. The joining surface cooperates with the at least one groove portion of the at least one corrugated sheet to create at least one passageway. The at least one passageway is configured for the passage of fluid.

According to another aspect of the invention, a heat exchanger is provided. The heat exchanger includes at least two corrugated sheets. Each of the at least two corrugated sheets has at least one joining portion and at least one groove portion. The at least two corrugated sheets are joined together at the at least one joining portion. The at least two corrugated sheets are provided in multiples of two. At least one passageway is created by the at least two corrugated sheets cooperating together at the at least one groove portion. The at least one passageway is configured for the passage of fluid.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of an exemplary motor assembly having a heat exchanger;

FIG. 2 is an illustration of a pair of corrugated sheets of the heat exchanger shown in FIG. 1;

FIG. 3 is an illustration of the corrugated sheets arranged in a nozzle configuration;

FIG. 4 is an illustration of the corrugated sheets arranged in a diffuser configuration;

FIG. 5 is an illustration of the corrugated sheets in a zigzag configuration;

FIG. 6 is an assembly view of a pair of corrugated sheets;

FIG. 7 is a view of one of the corrugated sheets shown in FIG. 6;

FIG. 8 is an alternative embodiment of one of the corrugated sheets shown in FIG. 2;

FIG. 9 is another alternative embodiment of one of the corrugated sheets shown in FIG. 2; and

FIG. 10 is yet another alternative embodiment of one of the corrugated sheets shown in FIG. 2.

The detailed description explains embodiments of the invention, together with advantages and features, by way of example with reference to the drawings.

### DETAILED DESCRIPTION OF THE INVENTION

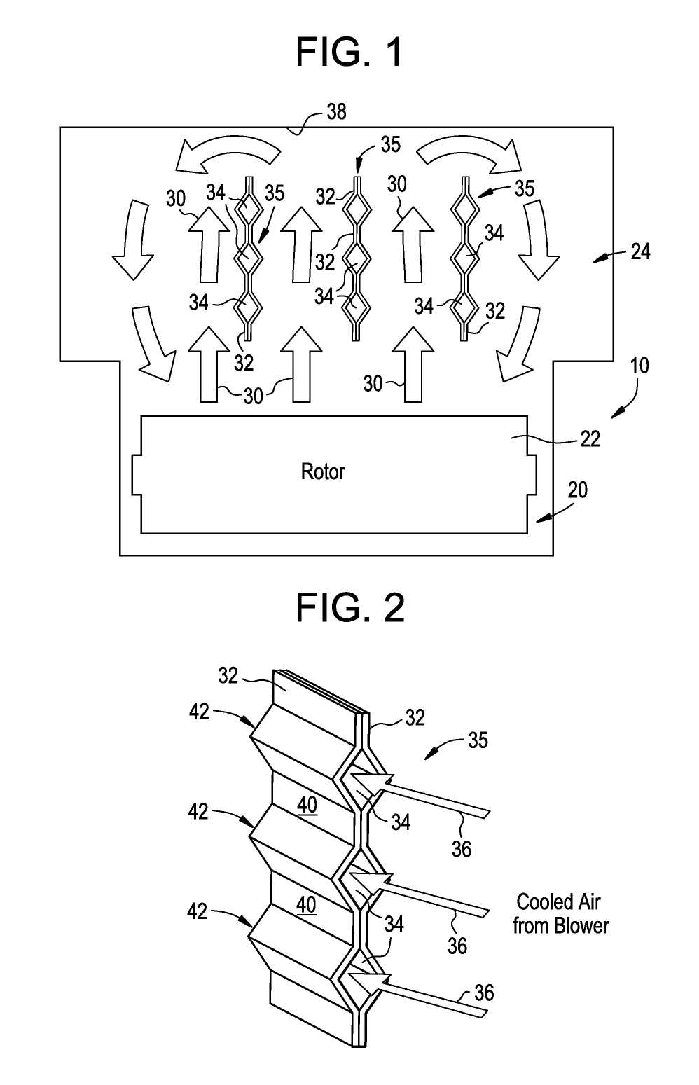

FIG. 1 is a schematic illustration of an exemplary motor assembly 10. The motor assembly 10 includes a motor 20 having a rotor 22, and a heat exchanger 24. In one embodiment, the motor 20 may be a medium or large electrical motor (typically having a power output of at least about 500 HP), however it is to be understood that any type of mechanical machine may be used as well. During operation of the motor 20, the rotor 22 directs heated air 30 created by operation of the motor 20 towards the heat exchanger 24. The heated air 30 is cooled by a series of corrugated sheets 32 that are part of the heat exchanger 24. In the embodiment as shown in FIG. 1, the motor assembly 10 includes a top-hat configuration. A top-hat configuration typically has the heat exchanger 24 positioned over the motor 20, however it is to be understood that other configurations may be used as well for the motor assembly 10. Moreover, although FIG. 1 illustrates the heat exchanger 24 employed in the motor assembly 10, it is to be understood that the heat exchanger 24 may be employed in a variety of applications. Also, although FIG. 1 illustrates the heat exchanger 24 integral with the motor assembly 10, the heat exchanger 24 may be a stand-alone part as well. FIG. 2 is an illustration of a pair of corrugated sheets 32 that have been joined together. Although two corrugated sheets 32 have been illustrated, it is to be understood that one corrugated sheet and a generally planar sheet may be used as well. Specifically, with reference to both FIGS. 1-2, the corrugated sheets 32 are arranged together in multiples of two to create discrete cabinet assemblies 35. That is, two of the corrugated sheets 32 that have been joined together create a discrete cabinet assembly 35. FIG. 1 illustrates three cabinet assemblies 35 that are included as part of the heat exchanger 24, however it is to be understood that any number of cabinet assemblies 35 may be used as well depending on heat transfer requirements. The corrugated sheets 32 cooperate together to create passageways 34. In one embodiment, a fluid such as, for example, cooling air 36 provided by a blower (not shown) flows through the passageways 34, and thereby may provide cooling to the heated air 30. The passageways 34 are configured for the passage of the cooling air 36. The heated air 30, which has been cooled by the heat exchanger 24, is then redirected back towards the motor 20 by a surface 38 of the heat exchanger 24. The corrugated sheets 32 are arranged in generally vertical configuration as shown in FIG. 1, where the rotor 22 directs heated air 30 created by operation of the motor 20 towards the heat exchanger 24. FIG. 1 also illustrates the heat exchanger 24 oriented generally vertical in relation to the motor 20. Alternatively, in another embodiment, the heat exchanger 24 may include corrugated sheets 32 that are oriented in a generally horizontal configuration as well. Moreover, the corrugated sheets 32 may also be oriented generally horizontal to the motor 20 as well. In other words, the heat exchanger 24 may be mounted generally vertical or horizontal to motor 20, with the corrugated sheets 32 being oriented in a generally horizontal or vertical configuration. Although FIGS. 1-2 describe cooling air 36, it is to be understood that any type of fluid may be used as well such as, for example, a liquid such as coolant, or a gas.

The cabinet assemblies 35 may each be of the same shape and size, or, alternatively, may be of different shapes and sizes with a different number of pocketed passageways 34. Any other approach to ensure the modularity and the ease of replacement of the cabinet assemblies 35 either for repair or for adjusting the heat transfer or other performance requirements of the heat exchanger 24 is included in one of the embodiments. It is also understood that the cabinet assemblies 35 may also include a different number of passageways 34 between the cabinet assemblies 35 as well, where a portion the cabinet assemblies 35 have a greater number of passageways 34 than the remaining cabinet assemblies 35. Moreover, it is also understood that different types of cooling mediums may pass through the passageways 34, where one of the cabinet assemblies 35 may have an air-cooling medium and another one of the cabinet assemblies 35 may have a fluid-cooled medium in the same heat exchanger 24.

Referring specifically to FIG. 2, each of the corrugated sheets 32 include at least one joining portion 40 and at least one raised portion or groove 42. The corrugated sheets 32 are joined together at the respective joining portions 40 by any type of joining process available. For example, the corrugated sheets 32 may be joined together by riveting, stitch welding, or spot welding. The respective grooves 42 cooperate together to create the passageways 34. In one embodiment, a single corrugated sheet 32 and a generally planar sheet (not shown) may be used as well, where the corrugated sheet 32 is joined to the generally planer sheet. In this embodiment, the joining portion 40 is joined to the generally planar sheet, and the at least one raised portion or groove 42 cooperates with the generally planar sheet to create the passageway 34. A gasket or sealing material (not shown) may be used at the corrugated sheets 32 and/or at the joining portions 40 to ensure leakage does not generally occur from each of the passageways 34 and exits. However, in another embodiment, the corrugated sheets 32 are relatively gasket-free.

In one embodiment, the corrugated sheets 32 may be constructed from a metal-based material such as, for example, a copper based material, an aluminum based material, or a low carbon steel or any other thermally conducting material. In one embodiment, the corrugated sheets 32 may also include a thermally conductive plating or coating as well. It should be noted that while FIG. 2 illustrates a single-ply corrugated sheet 32, it is to be understood that double-ply corrugated sheets may be used as well, depending on the heat transfer requirements of the heat exchanger 24 (shown in FIG. 1).

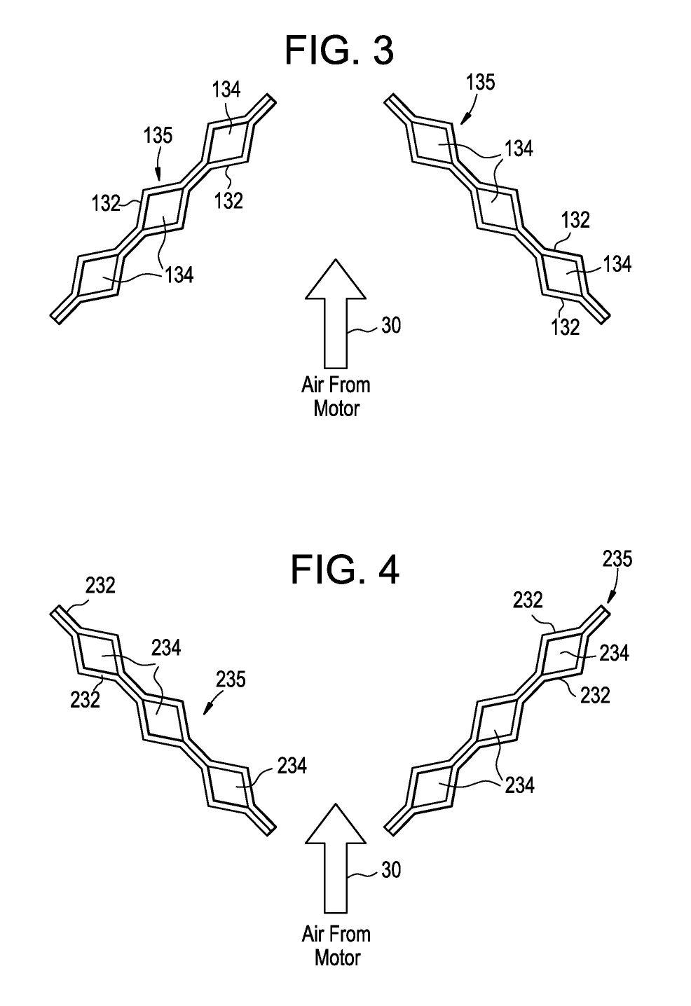

The cabinet assemblies 35 may be arranged in a variety of configurations as well, depending on the heat transfer requirements of the heat exchanger 24. For example, FIGS. 3-4 are schematic illustrations of various arrangements of the cabinet assemblies 35 in the heat exchanger 24 (shown in FIG. 1). Specifically, FIG. 3 is an illustration of a nozzle type or converging arrangement of the cabinet assemblies 135, where corrugated sheets 132 are directed inwardly towards the surface 38 of the heat exchanger 24 (shown in FIG. 1). FIG. 4 is an illustration of a diffuser or diverging arrangement of the cabinet assembly 235, where corrugated sheets 232 are directed outwardly towards the surface 38 of the heat exchanger 24 (shown in FIG. 1). Arranging the cabinet assemblies 135 and 235 in either a nozzle or a diffuser type of arrangement may aid in reducing the pressure drop and or increasing the velocity of the heated air 30 (shown in FIG. 2) that travels over the respective cabinet assemblies. However, it is to be understood that the cabinet assemblies may include a generally straight passage arrangement in one embodiment as well.

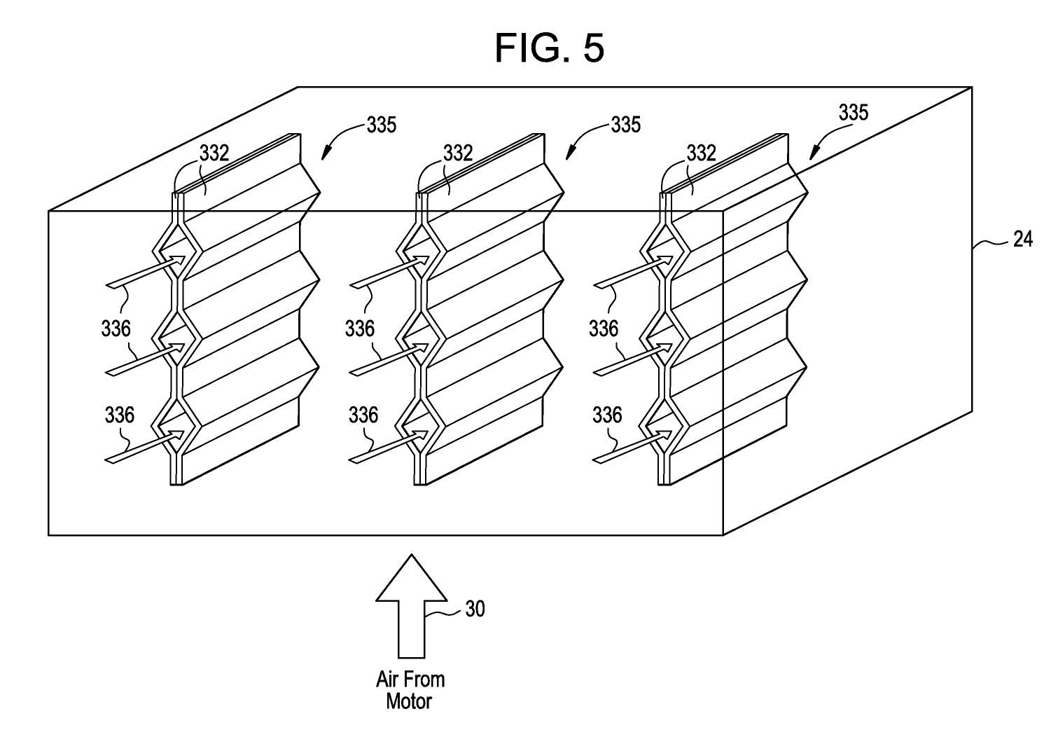

In yet another embodiment as shown in FIG. 5, the heat exchanger 24 may include a plurality of cabinet assemblies 335 that are arranged in a zigzag configuration in relation to one another. The corrugated sheets 332 are arranged in the staggered configuration in an effort to increase the turbulence of the heated air 30 from the motor 20 (shown in FIG. 1). Although a zigzag configuration is shown in FIG. 5, it is to be understood that the cabinet assemblies 335 may be arranged in any type of staggered configuration for increasing the turbulence of the heated air 30 as well. It is also understood that the cabinet assemblies 335 may also be assembled in an inclined fashion along with the zigzag configuration.

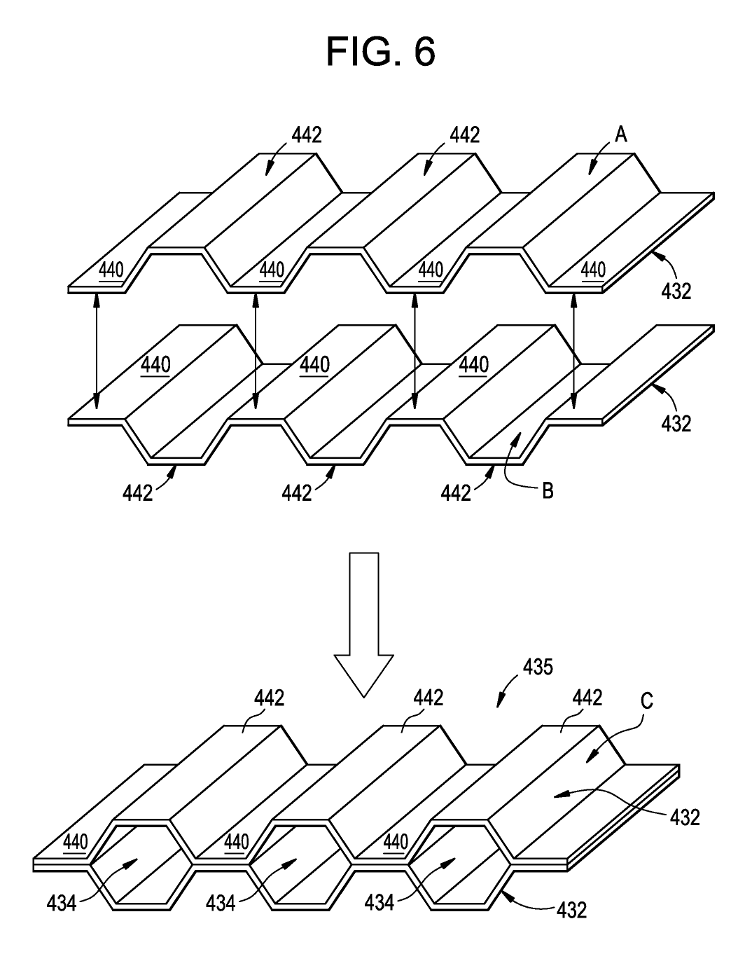

FIG. 6 is an assembly view of a pair of corrugated sheets 432, where corrugated sheets ‘A’ and ‘B’ are shown separate from one another, prior to joining. The joining portions 440 of each of the corrugated sheets 432 are shown generally opposing one another. The corrugated sheets ‘A’ and ‘B’ are joined together using any type of joining process available to create a finished product, which is labeled as ‘C’. Once the two corrugated sheets ‘A’ and ‘B’ are joined together, a cabinet assembly 435 is created. The cabinet assembly 435 includes a plurality of passageways 434. In the embodiment as shown in FIG. 6, the passageways 434 include a generally hexagonal cross-section, however it is to be understood that a variety of different cross-sections may be used for the passageways. For example, FIG. 2 illustrates the passageways 34 including a generally square cross-section. It is also understood that the two corrugated sheets A and B that are being joined to form the passageways 434 may have different groove configurations, which may result in uniform or non-uniform passageways 434 that may be periodic or non-periodic in nature. It is also to be understood that one generally flat sheet (not shown) is joined to any other corrugated sheet 32 resulting in the passageways having a half pocket or a full pocket configuration (i.e. generally semi-circular). A single passageway 434 may also be formed by joining a face of one or more corrugated sheets 432 with another face of another corrugated sheet 432.

In yet another embodiment, the passageways may include a generally octagonal cross-section, a generally elliptical cross-section, a generally rectangular cross-section, or a generally rounded cross-section as well. It is understood that any arrangement where leakage from one passageway enters into another passageway instead of mixing with other fluid mediums (such as the heated air 30 shown in FIG. 1) may also be employed.

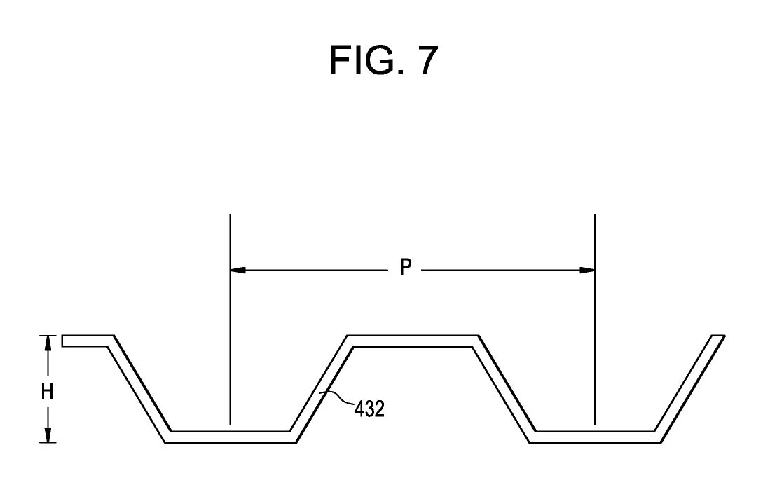

It should be noted that the configuration of the passageways 434 may be adjusted based on heat transfer or other performance requirements of the heat exchanger 24 (shown in FIG. 1). For example, FIG. 7 is an illustration of one of the corrugated sheets 432 having a pitch P and a height H. The pitch P and the height H of the corrugated sheet 432 may be adjusted depending on the heat transfer requirements or other performance requirements of the heat exchanger 24 (shown in FIG. 1). For example, the height H of the corrugated sheet 432 may be adjusted to provide a required pressure drop. Although FIG. 6 illustrates two generally identical corrugated sheets A and B, it is to be understood that the corrugated sheets A and B may have differing pitches P and heights H as well. Two corrugated sheets 432 where the pitch P is different may also still be used, which results in passageways 434 having a generally semi-circular or similar type of configuration.

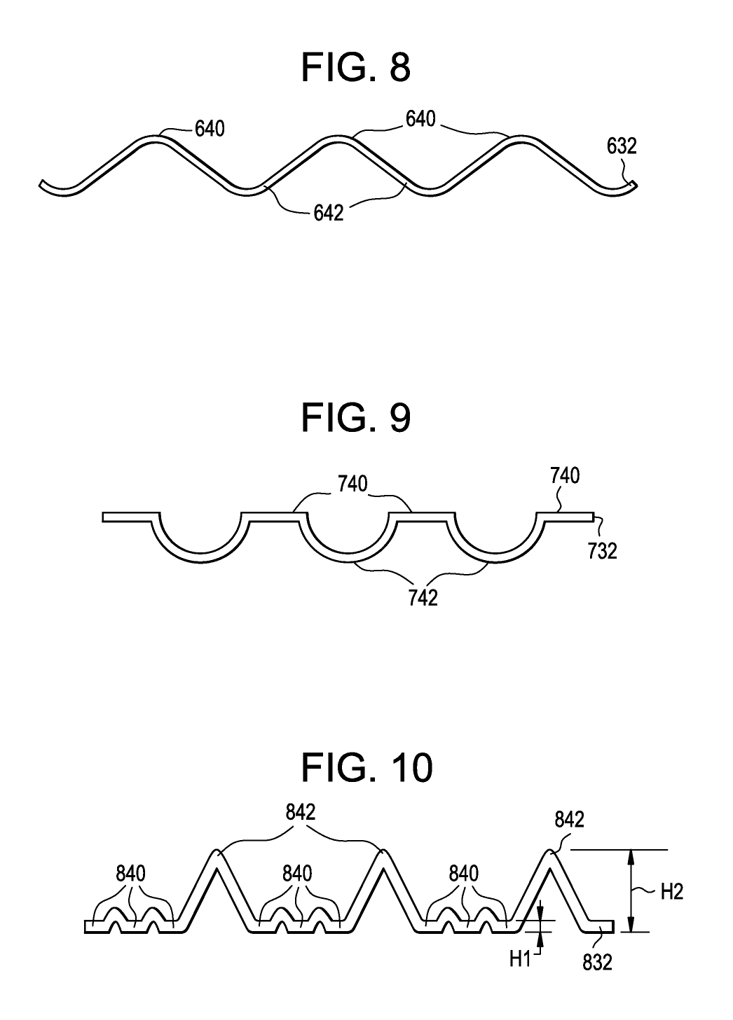

The corrugated sheets 432 may have a variety of configurations. For example, in one embodiment the corrugated sheets 432 may conform to Wide Rib corrugated sheet, which is an industry standard in the field of industrial roofing. FIGS. 8-10 are illustrations of various exemplary configurations that may be used for the corrugated sheets. For example, FIG. 8 is an illustration of a corrugated sheet 632 having a generally rounded profile having at least one generally rounded joining portion 640 and at least one generally rounded groove 642. In yet another embodiment as shown in FIG. 9, a corrugated sheet 732 includes at least one generally flattened joining portion 740. The corrugated sheet 732 also includes at least one groove 742 having a generally semi-circular profile. In still yet another embodiment as shown in FIG. 10, a corrugated sheet 832 is provided, where the corrugated sheet 832 includes at least one joining portion 840 and a plurality of grooves 842 having different heights. Specifically, some of the joining portions referred to with reference ‘H1’ have a height that is less than the remaining joining portions having a height that is referred to with reference ‘H2’.

Referring generally to FIGS. 1-10, the corrugated sheets provide reduced cost, weight, and complexity when compared to crossover tubes that are currently being used in heat exchangers. Specifically, the manufacturing processes that are currently employed to create the crossover pipes are usually time-consuming and relatively costly when compared to corrugated sheets. Moreover, the corrugated sheets provide less air resistance when compared to crossover pipes. Therefore, a less powerful blower is supplied in the event corrugated sheets are employed. Also, corrugated sheets typically have a higher stiffness than crossover pipes. Therefore, a support member that is typically used with crossover pipes is also eliminated when using the corrugated sheets. A punched sheet that is usually provided with the crossover pipes is also eliminated as well when employing the corrugated sheet as taught herein. Referring specifically to FIGS. 1-2, the joining portions 40 of the corrugated sheets 32 also do not generally require leak-free joining between each of the passageways 34. This is because if one of the passageways 34 develops a leak, the cooling air 36 or other type of fluid may leak into another one of the passageways 34. In contrast, if one of the crossover pipes develops a leak, the cooling air or fluid would leak into the heated air 30. Also, the net thermal convective surface area offered to the heated air 30 by the cabinet assemblies 35 is typically relatively much higher than the crossover pipe construction, which in turn may result in net overall weight reduction of the heat exchanger 24.

Continuing to referring to both FIGS. 1-2, the corrugated sheets 32 are arranged together in multiples of two to create the discrete cabinet assemblies 35. The discrete cabinet assemblies 35 provide a modular configuration or design such that if a relatively small heat exchanger 24 is needed, a fewer number of cabinet assemblies 35 are used. Likewise, if the heat exchanger 24 needs to increase in size, a greater number of cabinet assemblies 35 are used. This approach standardizes the construction of the heat exchanger 24, and also provides service enhancements as well, as only each cabinet assembly 35 needs to be replaced at a time. The cabinet assemblies 35 include modularity, which means that each cabinet assembly 35 may be used multiple times. The cabinet assemblies 35 provide simplicity in manufacturing and assembly, and also substantially reduce or eliminate leakage issues, field replacement and field repair issues as well.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of creating a heat exchanger, comprising:
providing at least one corrugated sheet, the at least one corrugated sheet having at least one joining portion and at least one groove portion;
providing a joining surface for the at least one corrugated sheet; and
joining the at least one corrugated sheet at the least one joining portion with the joining surface, the joining surface cooperating with the at least one groove portion of the at least one corrugated sheet to create at least one passageway, the at least one passageway being configured for the passage of fluid.

2. The method as recited in claim 1, comprising joining the at least one corrugated sheet and the joining surface together by at least one of a riveting, stitch welding, and spot welding.

3. The method as recited in claim 1, wherein the joining surface is another corrugated sheet and at least two corrugated sheets in multiples of two are provided.

4. The method as recited in claim 3, comprising providing the at least one passageway with one of a generally square cross-section, a generally hexagonal cross-section, a generally octagonal cross-section, a generally elliptical cross-section, a generally semi-circular cross-section, and a generally rounded cross-section.

5. The method as recited in claim 3, comprising determining a heat transfer requirement of the heat exchanger, and wherein one of single-ply and double-ply corrugated sheets are provided for the at least two corrugated sheets depending on the heat transfer requirement.

6. The method as recited in claim 3, comprising providing a plurality of corrugated sheets, wherein a pair of the plurality of corrugated sheets are joined together create a cabinet assembly, and wherein the cabinet assembly includes a modular configuration.

7. The method as recited in claim 6, comprising providing a plurality of cabinet assemblies, wherein the plurality of cabinet assemblies are oriented in one of a generally straight passage arrangement, a diffuser arrangement and a nozzle arrangement.

8. The method as recited in claim 7, comprising providing a plurality of cabinet assemblies, wherein the plurality of cabinet assemblies are oriented in one of a zigzag configuration and a staggered configuration, and wherein at least a portion of the plurality of cabinet assemblies include at least one of the diffuser arrangement and the nozzle arrangement.

9. The method as recited in claim 8, wherein another portion of the cabinet assemblies include a number of passageways, and a remaining portion of the cabinet assemblies include another number of passageways that are greater than the number of passageways.

10. The method as recited in claim 3, comprising providing a plurality of passageways, wherein fluid is configured for exiting one of the plurality of passageways and entering into another one of the plurality of passageways between the at least two corrugated sheets.

11. The method as recited in claim 3, wherein the at least two corrugated sheets are constructed from one of a copper based material, an aluminum based material, and a low carbon steel.

12. The method as recited in claim 3, comprising determining a heat transfer requirement of the heat exchanger, wherein each of the at least two corrugated sheets include a height and a pitch, and wherein the height and the pitch depend at least in part on the heat transfer requirement.

13. A heat exchanger, comprising:
at least two corrugated sheets, each of the at least two corrugated sheets having at least one joining portion and at least one groove portion, the at least two corrugated sheets joined together at the at least one joining portion, the at least two corrugated sheets being provided in multiples of two; and
at least one passageway created by the at least two corrugated sheets cooperating together at the at least one groove portion, the at least one passageway being configured for the passage of fluid.

14. The heat exchanger as recited in claim 13, wherein the at least two corrugated sheets are joined together by at least one of a riveting, stitch welding, and spot welding, and wherein the at least two corrugated sheets are one of substantially gasket-free and include a gasket.

15. The heat exchanger as recited in claim 13, wherein the at least one passageway includes one of a generally square cross-section, a generally elliptical cross-section, a generally semi-circular cross-section, a generally hexagonal cross-section, a generally octagonal cross-section, and a generally rounded cross-section.

16. The heat exchanger as recited in claim 13, wherein the heat exchanger includes a heat transfer requirement, and wherein one of single-ply and double-ply corrugated sheets are provided for the at least two corrugated sheers depending on the heat transfer requirement.

17. The heat exchanger as recited in claim 13, wherein the heat exchanger includes a plurality of corrugated sheets, wherein a pair of the plurality of corrugated sheets joined together create a cabinet assembly, and wherein a plurality of cabinet assemblies are provided where one of the plurality of cabinet assemblies has an air-cooling medium and another one of the plurality of cabinet assemblies has a fluid-cooled medium.

18. The heat exchanger as recited in claim 17, wherein the plurality of cabinet assemblies are provided, and wherein the plurality of cabinet assemblies are oriented in one of a generally straight passage arrangement, a diffuser arrangement and a nozzle arrangement.

19. The heat exchanger as recited in claim 13, wherein the heat exchanger includes a heat transfer requirement, wherein each of the at least two corrugated sheets include a height and a pitch, and wherein the height and the pitch depend at least in part on the heat transfer requirement.

20. A motor assembly, comprising:
a motor creating a heated air during operation;
a heat exchanger fluidly connected to the motor and receiving the heated air, wherein the heat exchanger is oriented one of generally vertically and generally horizontal in relation to the motor, comprising:
at least two corrugated sheets, each of the at least two corrugated sheets having at least one joining portion and at least one groove portion, the at least two corrugated sheets joined together at the at least one joining portion, the at least two corrugated sheets being provided in multiples of two; and
at least one passageway created by the at least two corrugated sheets cooperating together at the at least one groove portion, the at least one passageway being configured for the passage of fluid.
